(19) United States
(12) Patent Application Publication
(10) Pub. No.: US 2026/0115513 A1
(43) Pub. Date: Apr. 30, 2026

(54) A Protection and Installation Device for Fire Protection Sprinklers

(71) Applicant: Minimax Viking Patent Management GmbH, Bad Oldesloe (DE)

(72) Inventor: Michael James OLDHAM, Kalamazoo, MI (US)

(21) Appl. No.: 19/164,023

(22) PCT Filed: Mar. 8, 2025
(86) PCT No.: PCT/US2025/019075

§ 371 Date: Sep. 10, 2025

Related U.S. Application Data
(60) Provisional application No. 63/563,172, filed on Mar. 8, 2024.

(51) Int. Cl. A62C 35/68; B05B 15/16

(52) U.S. Cl. CPC A62C 35/68; B05B 15/16

(57) ABSTRACT

A device and method for protecting and installing a fire protection sprinkler. The protective and installation device has two discrete protective members coupled to one another about the sprinkler by a connection between the two discrete protective members that includes a releasable locking arrangement. At least one of the members includes a torque assist portion for applying torque to the fire protection sprinkler and each of the members includes a deflector protection portion. The discrete protective members include projections that extend toward each other to overlap each other and surround a maximum radial extent of frame arms of the sprinkler.

### TECHNICAL FIELD

The present invention relates generally to protection devices and installation tools for fire protection sprinklers and systems. In particular, the present invention relates to a protective cover and installation device for fire protection sprinklers that allows for manual installation of the fire protection sprinkler.

### BACKGROUND ART

Fire protection devices (e.g., sprinklers) include a frame body with an inlet connected to a pressurized supply of firefighting fluid, such as water, and some type of fluid deflector spaced from an outlet of the frame body to distribute firefighting fluid discharged from the outlet in a defined spray distribution pattern over an area to be protected. Fire protection devices are used, for example, in the protection of storage commodities and occupancies. Storage fire protection systems include a network of pipes connected to a firefighting fluid supply and installed above the storage commodity beneath the ceiling of the occupancy. The piping network includes one or more branch lines coupled to a cross-main which is connected to a fluid supply by a vertical piping riser to supply the branch line(s) with the firefighting fluid. Fire protection devices are connected to the branch lines in an appropriate orientation and at an appropriate spacing between the fire protection devices.

In some fire protection devices, the release of fluid discharge from the body is controlled. For example, automatic fire protection sprinklers include a fusible or thermally responsive trigger assembly which secures a seal over an internal central orifice formed proximate the outlet of the frame body. When the temperature surrounding the automatic sprinkler is elevated to a pre-selected value indicative of a fire, the trigger assembly operates, fractures or collapses to release the seal assembly and fluid flow is initiated through the sprinkler body and out the outlet to impact the fluid deflector. In other types of controlled sprinklers, the trigger and/or seal is operated or otherwise ejected by a mechanical, electrical or computer-controlled actuator.

The response and actuation of the fire protection device is based upon a thermally responsive trigger or actuator; and the spray pattern or distribution of the firefighting fluid is defined by the fluid deflector configuration. Accordingly, proper performance is a function of these operative components. In order to protect the operative components of the fire protection device during the installation process it is preferred to keep a protective device on the fire protection device. U.S. Pat. No. 12,157,022 (the “'022 patent”) discloses a protective device that allows the installer to manually torque the fire protection device into the gasketed branch connector so as to form a fluid tight sealed connection. The protective device of the '022 patent includes opposing protective members that at least partially surround the fire protection device. As the outer surface of the protective device is grasped and manually twisted, the protective members grip and apply a torque onto the fire protection device to thread the fire protection device into the branch connector. However, if the grip on the protective device is improper, there is a potential for the protective members to move laterally relative to each other and/or relative to the fire protection device during the hand-torqued installation. Such lateral movement by the protective members risks contact between the protective members (or other components) of the protective device and the operative components of the fire protection device such as, for example, the thermally responsive trigger assembly. If the contact is severe enough, there is a potential that the operative components can get damaged. Accordingly, there is a need for protective devices that can protect operative components of the fire protection device during storage, transport handling and installation; transfer a torque or rotational force to form a fluid tight sealed connection between a fire protection device and a branch connector while minimizing the risk of contact with operational components of the fire protection device (e.g., by minimizing the lateral movement of the protective device during installation); and be easily removable in order to place the fire protection device into service.

### DISCLOSURE OF THE INVENTION

Preferred embodiments of a method of protecting and installing a fire protection device (e.g., an automatic and/or activated fire protection sprinkler, a mist device, a nozzle, or any structure configured to distribute a firefighting fluid, solution, or gas) are achieved by providing a protected fire protection assembly. For brevity and clarity, the protected fire protection assembly is described using a preferred embodiment of a protected fire protection assembly that includes, for example, a fire protection sprinkler and a protective device. However, embodiments of the present disclosure can also apply to protected fire protection assemblies that include mist devices, nozzles, or other structures configured to distribute a firefighting fluid. The protective device, preferably, includes two discrete protective members that are opposed and coupled to one another in a releasable locked arrangement that defines an internal void for housing and protecting at least a portion of a fire protection sprinkler. The protective members of the preferred protective device include a solid wall, and, preferably, an impervious wall, that confronts the fire protection sprinkler and provides a torque assist portion and a deflector protection portion. Each torque assist portion can include one or more projecting elements that resist lateral movement of the protective members (and thus stabilize the protection device) by contacting one or more projecting elements of an opposing torque assist portion, which prevents further movement, when a torque force is applied on the protection device during installation of the fire protection sprinkler. Preferably, the projecting elements are fin-shaped (also referred to herein as “stabilizing fins”).

A preferred embodiment for the protected fire protection sprinkler assembly includes a fire protection sprinkler including a body having an inlet, an outlet, an internal passageway extending between the inlet and the outlet along a central sprinkler axis, and an external thread formed about the central sprinkler axis. A pair of spaced apart frame arms are disposed in a plane and extending axially from the body and converge toward one another to affix to a support structure, and preferably the support structure is an apex formed by the convergence of the frame arms (“apex”), along the central sprinkler axis and spaced axially from the outlet. A thermally responsive trigger is disposed along the central sprinkler axis between the outlet and the support structure (e.g., the apex). The thermally responsive trigger is a component that responds and operates passively to an increase in temperature. The thermally responsive trigger can be included in an assembly to provide a thermally responsive trigger assembly. A fluid deflector is affixed to the support structure (e.g., the apex). The fluid deflector, preferably, has an outer perimeter that surrounds the support structure (e.g., the apex). The fluid deflector can be configured for various fire sprinkler protection position installations, such as, pendent, upright and/or horizontal, and can be also configured to control, suppress, and/or address a fire by distribution of a firefighting fluid, such as, water or a water-concentrate solution.

The preferred embodiment for the protected fire protection sprinkler assembly also includes a protective device disposed about the fire protection sprinkler. The preferred, protective device including a first protective member and a second protective member opposed from one another about the plane to at least partially surround the thermally responsive trigger. The first protective member and the second protective member defining a torque assist portion and a deflector protection portion. The torque assist portion, preferably, includes a plurality of torque assist surfaces contiguous with the pair of spaced apart frame arms of the fire protection sprinkler.

The first protective member and the second protective member also include one or more engagement mechanisms. If two or more are included, the engagement mechanisms can be different from one another. In some embodiments, the first and second protective members can include a top engagement mechanism that can include an overlapping friction fit and a bottom engagement mechanism that can include a releasable fit (e.g., a snap fit). For example, the first protective member and the second protective member can include a bottom engagement mechanism such as, for example, a releasable lock arrangement including a first and a second releasable lock arrangement; each releasable lock arrangement extending through the plane in which the pair of frame arms are disposed and proximate the support structure (e.g., the apex) of the fire protection sprinkler. The first releasable lock arrangement being disposed proximate a first lateral portion of the support structure (e.g., the apex) and the second releasable lock arrangement being disposed proximate a second lateral portion of the support structure (e.g., apex). The preferred protective device includes a releasing segment aligned with the first releasable lock arrangement and second releasable lock arrangement. In some embodiments, the first and second protective members can include a top engagement mechanism that is spaced apart from the bottom engagement mechanism (e.g., away from the support structure, e.g., apex, and the releasable lock arrangement) and includes one or more projecting elements (e.g., stabilizing fins) extending from a respective protective member toward corresponding one or more stabilizing fins of the other protective member. In some embodiments, each projecting element (e.g., stabilizing fin) can have an overlapping friction fit engagement with a projecting element (e.g., stabilizing fin) of an opposing protective member. Preferably, each torque assist portion of the first and second protective members includes the top and bottom engagement mechanisms. In some embodiments, the opposing projecting elements (e.g., stabilizing fins) are spaced apart from each other (e.g., do not contact each other) and the first and second protective members include just the bottom engagement mechanism.

In a preferred embodiment, the protected fire protection sprinkler assembly includes a fire protection sprinkler and a protective device disposed about the fire protection sprinkler. The protective device includes a first protective member and second protective member opposed from one another about a plane to at least partially surround a thermally responsive trigger. Preferably, each of the first protective member and the second protective member includes an impervious wall. The impervious wall provides a shield for the fire protection sprinkler. The shields are secured together in an opposed manner by a releasable lock arrangement, which provides the only interconnection between the shields.

In a preferred embodiment, each impervious wall or shield, preferably, includes a first end located between a body, and, in particular, an outlet of the body, and a support structure, preferably an apex, that supports a fluid deflector of the fire protection sprinkler and a second end that surrounds an outer perimeter of the fluid deflector of the fire protection sprinkler. The impervious wall also, preferably, includes at least a pair of lateral torque assist surfaces proximate the first end with each of the pair of lateral torque assist surfaces being contiguous with a pair of spaced apart frame arms of the fire protection sprinkler. The impervious wall also includes a pair of locking elements disposed about the support structure (e.g., the apex), and a releasing segment proximate the second end and aligned with the pair of locking elements. The impervious wall can also include an engagement mechanism that can be spaced apart from the pair of locking elements (e.g., away from the support structure, e.g., apex) and can include an overlapping friction fit.

Preferably, the first end of the impervious wall comprises a shield segment. The shield segment comprises a concave segment and two convex segments laterally disposed about the concave segment. The concave segment confronts, and preferably is contiguous to the two convex segments and an inflection transition is between the concave segment and each of the convex segments. The pair of lateral torque assist surfaces comprise a first lateral torque assist surface contiguous with a first of the two convex segments and a second lateral torque assist surface contiguous with a second of the two convex segments. The first lateral torque assist surface comprises a first planar member extending parallel to the plane, and the second lateral torque assist surface comprises a second planar member extending parallel to the plane.

Preferably, alternatively, and/or additionally, the first end comprises a torque assist portion and a central section of the impervious wall comprises a central plurality of segments that narrow between the first end and the second end. Preferably, each of the plurality of central segments includes a curved portion disposed along the central sprinkler axis and a planar portion transverse to a central sprinkler axis of the fire protection sprinkler.

Preferably, alternatively, and/or additionally, the first end of the impervious wall includes a trigger shield segment for protecting the thermally responsive trigger assembly. The trigger shield segment has a first maximum radius from a central sprinkler axis of the fire protection sprinkler. The second end that surrounds the perimeter of the deflector includes a peripheral shielding surface for protecting the fluid deflector. The peripheral shielding surface has a second maximum radius from the central sprinkler axis, and the second maximum radius is greater than the first maximum radius.

Preferably, alternatively, and/or additionally, the second end that surrounds the perimeter of the deflector comprises a first radially extending shielding surface and a peripheral shielding surface that at least partially circumscribes the outer perimeter of the fluid deflector. The second end, preferably, includes a second radially extending shielding surface, and wherein the peripheral shielding surface extends between the first radially extending shielding surface and the second radially extending shielding surface.

Preferably, and/or additionally, a pair of lock elements comprise an insert and a receiver, and the releasing segment comprises a planar member extending parallel to the plane from one of a first longitudinal side of the impervious wall or a second longitudinal side of the impervious wall. In some embodiments, the overlapping friction fit of the impervious wall includes one or more projecting elements (e.g., stabilizing fins) extending perpendicular to the plane and overlapping with opposing one or more projecting elements (e.g., stabilizing fins) extending perpendicular to the plane. Preferably, the opposing surfaces of the overlapped projecting elements (e.g., stabilizing fins or any suitable projections) are planar surfaces.

In preferred embodiments, the protected fire protection sprinkler assembly includes a pipe header having internal fluid passageway extending along a longitudinal axis with the pipe header having an opening formed therein. A branch connector can include a tubular member (e.g., unitary tubular member) having a first terminal end, and a second terminal end spaced from the first terminal end. The tubular member can include an internal gasket chamber surface between the first terminal end and the second terminal end. Preferably. an annular seal member (e.g., single annular seal member) can be housed in the tubular member and supported therein by the internal gasket chamber surface, an internally threaded surface between the gasket chamber surface and the second terminal end, and an internal surface (e.g., stepless surface) extending from the first terminal end to the internal gasket chamber surface. Preferably, the first terminal end is preferably connected to the opening in the pipe header (e.g., connected via welding, or glued, or integrally formed, or the connector and header can be a pre-made fitting) with the surface in fluid communication with the internal fluid passageway of the pipe header.

Preferably, a fire protection device includes a frame having a frame body with a frame inlet, a frame outlet and a frame internal passageway extending from the frame inlet to the frame outlet along a device axis. Preferably, the frame body can be in a threaded engagement with the internally threaded surface of the tubular member to compress the annular seal member and establish the frame internal passageway of the fire protection device in fluid communication with the fluid passageway of the pipe header.

Preferably, the fire protection device includes a fluid deflection member coupled to the frame and a protective cap disposed over the fluid deflection member. The protective cap can include an internal surface for engaging and gripping the frame and an external surface for applying a torque to the protective cap to thread in the fire protection device into engagement with the internally threaded surface of the tubular member. Preferably, the internal surface prevents relative rotation between the protective cap and the fire protection device. The protective cap can include a first protective member and a second protective member, each of the first and second protective members can include a torque assist portion. Preferably, each torque assist portion can include one or more projecting elements extending toward and at least partially surrounding the frame body of the fire protection device.

In preferred embodiments, the protected fire protection sprinkler assembly includes a branch connector having a body with a first end for coupling to a water supply line and a second end having internal threads for threadably receiving a fire sprinkler head. Preferably, the body can include an annular sealing surface at the end of the threads. An annular seal can include an annular body having a central opening with an outwardly tapered conical wall. The conical wall can terminate in a first annular surface at one end and a second annular surface at an opposite end. Preferably, the seal has an outer surface including an inwardly tapered outer conical wall extending to the one end of the seal. The first annular surface can be adapted to sealably engage the annular sealing surface of the body and the second annular surface can be adapted to be sealably engaged by a sprinkler head.

Preferably, a fire protection sprinkler can include a body having an inlet, an outlet, an internal passageway extending between the inlet and the outlet along a central sprinkler axis, and an external thread formed about the central sprinkler axis. Preferably, a pair of spaced apart frame arms can be disposed in a plane and extend axially from the body and converge toward one another to form an apex along the central sprinkler axis and spaced axially from the outlet. A protective torque assist device can be disposed about the fire protection sprinkler, and the protective torque assist device can include a first protective member and second protective member opposed from one another about the plane. Preferably, each of the first protective member and the second protective member can include a torque assist portion having two lateral ends extending away from the central sprinkler axis, and each lateral end can include one or more projecting elements extending toward the plane to at least partially surround one of the frame arms.

In preferred embodiments, the protected fire protection sprinkler assembly can include a sprinkler body (e.g., a monolithic body) having opposite first and second ends and a threaded section adjacent the first end. A thermally responsive element can be mounted to the sprinkler body. Preferably, a branch connector can have opposite third and fourth ends and an internal passageway extending therebetween. The third end can be configured to attach to an access member of a piping system in fluid communication with the passageway. The passageway can have a threaded section adjacent the fourth end, and the threaded section can include a thread (e.g., straight thread). The passageway can include an annular recess section having an outer wall with an inner diameter that is larger than an inner diameter of the threaded section of the branch connector, and a shoulder that is disposed at an upstream end of the annular recess section. Preferably, a seal member can be disposed in the annular recess section against the shoulder of the passageway of the branch connector. The seal member can be annular and include a central opening aligned with the passageway. The first end of the sprinkler body can engage with and compress the seal member against the shoulder when the threaded section of the sprinkler body is engaged with the threaded section of the passageway and form a fluid-tight seal between the branch connector and the sprinkler body.

Preferably, a protective torque assist device can be disposed about the sprinkler, and the protective torque assist device can include a first protective member and second protective member opposed to the first protective member. Each of the first protective member and the second protective member can include a torque assist portion having two lateral ends extending away from a central sprinkler axis. Preferably, each lateral end includes one or more projecting elements extending toward the other protective member to at least partially surround a portion of the sprinkler body.

The preferred embodiments of the protected fire protection sprinkler assembly provide for a preferred method of installation, and, more preferably, a method for placing into service a fire protection sprinkler. The torque assist portion and deflector protection portion of the preferred embodiments of the protected fire protection sprinkler assembly allow for manually torquing the protected fire protection sprinkler assembly into a branch connector while providing damage protection to the fire protection sprinkler and/or harm or injury protection to the hand of a user that is manually torquing the protected fire protection sprinkler assembly. The protected fire protection sprinkler assembly is, preferably, manually torqued into the branch connector to compress a gasket in the branch connector and form a sealed connection between the protected fire protection sprinkler assembly and the branch connecter.

In preferred embodiments, a method of providing a protected fire sprinkler assembly includes placing an annular seal member in an unloaded condition within an internal gasket chamber of a tubular member (e.g., unitary tubular member) formed along an internal surface extending along and circumscribed about a central axis. Preferably, the gasket chamber can be located between an internally tapered threaded surface and an internal surface (e.g., stepless surface) of the internal surface. The internally threaded surface can be between the gasket chamber and a terminal outlet end of the tubular member. Preferably, the internal surface extends from the gasket chamber to a terminal inlet end of the tubular member that can be connected (e.g., welded, glued, integrally formed) to a pipe header. The method can include placing the annular seal member in a loaded condition within the internal gasket chamber with a fire protection device frame in threaded engagement with the internally threaded surface and fluid communication with the pipe header, and providing a protective torque assist device with two protective members, with each protective member having a torque assist portion and a deflector protection portion. The method can also include securing the protective members to one another with releasable locking elements. Preferably, securing the protective members to one another can include positioning projections of the torque assist portion to overlap with one another. Preferably, the projections are spaced apart from the releasable locking elements, and placing the annular seal member in the loaded condition includes torquing the device by hand with the protective torque assist device.

Each torque assist portion can include one or more projecting elements (e.g., stabilizing fins or any suitable projections) that can resist or prevent movement (e.g., lateral movement) of the protective members by contacting or interfering with one or more projecting elements (e.g., stabilizing fins or any suitable projections) of an opposing torque assist portion, which prevents further movement, when a torque force is applied on the protection device during installation of the fire protection sprinkler. Preferably, the one or more projecting elements (e.g., stabilizing fins or any suitable projections) overlap with corresponding one or more projecting elements (e.g., stabilizing fins or any suitable projections) of the opposing torque assist portion. In some embodiments, the overlapping projecting elements (e.g., stabilizing fins or any suitable projections) form a friction fit. In other embodiments, the overlapping projecting elements (e.g., stabilizing fins or any suitable projections) are spaced apart from each other (e.g., do not contact each other). Once the sealed connection is formed, the protective device of the protected fire protection sprinkler assembly is removed from the fire protection sprinkler. In particular, the protective device can be removed from the fire protection sprinkler by separating one of a pair of releasable lock arrangements that secures together the opposed shields of the preferred embodiment of the protected fire protection sprinkler assembly. Preferably, the separating at least one of the pair of releasable lock arrangements between the opposed shields is achieved by pulling a releasing segment aligned with the pair of releasable lock arrangements to place the fire protection sprinkler in a mode ready for servicing an area to be protected.

### BRIEF DESCRIPTION OF THE DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples of the invention as provided by the appended claims.

FIG. 1A is a partial cross-sectional exploded view of a preferred embodiment of a protected fire protection sprinkler assembly and an associated branch connector.

FIG. 1B is a partial cross-sectional phantom view of the protected fire protection sprinkler assembly coupled to the branch connector of FIG. 1A.

FIG. 2A is an exploded view of the preferred embodiment of the protected fire protection sprinkler assembly of FIG. 1A.

FIG. 2B is a cross-sectional plan view IIB in FIG. 1B of the protected fire protection sprinkler assembly of FIG. 1A.

FIG. 2C is a detailed view of FIG. 2B within portion IIC.

FIGS. 3A and 3B are perspective views of the protective device used in the protected fire protection sprinkler assembly in FIG. 1A.

FIG. 3C is an exploded perspective view of the protective device in FIG. 3A.

FIG. 4A is an exploded view of an alternate preferred embodiment of the protected fire protection sprinkler assembly of FIG. 1A.

FIG. 4B is a cross-sectional plan view of the protected fire protection sprinkler assembly of FIG. 4A (the cross-section being taken at a similar position as IIB in FIG. 1B).

FIG. 5 is an illustration of the preferred protected sprinkler assembly in FIG. 1A being installed by hand.

### MODE(S) FOR CARRYING OUT THE INVENTION

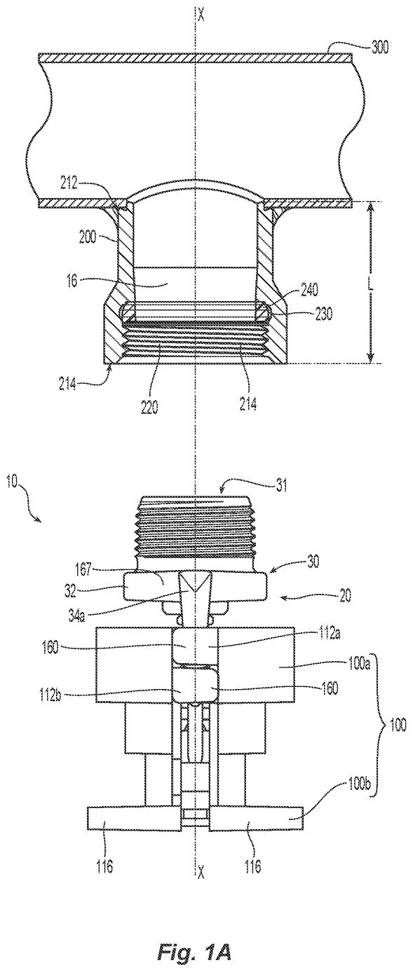

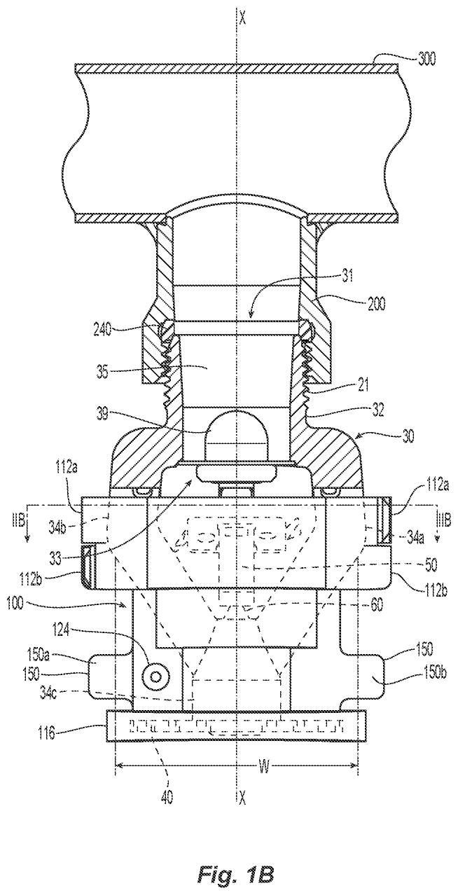

Shown in FIG. 1A is an exploded partial cross-sectional view of a preferred protected fire protection sprinkler assembly 10 having a fire protection sprinkler 20 and a protective device 100 for installation in a branch connector 200 connected to a fluid supply pipe header 300 (e.g., connected via welding, as shown, or glued, or integrally formed, or the connector 200 and header 300 can be a pre-made fitting). Preferred embodiments of the protective device 100 protect the sprinkler 20 from unintentional impact and damage during storage, transport, installation and/or when awaiting to be placed into service. Moreover, the protective device 100 also serves as a tool for installing the sprinkler 20 into the branch connector 200 of a fire protection sprinkler system. More specifically, the preferred device 100 facilitates installation of the sprinkler 20 by hand torquing the protected fire protection sprinkler assembly 10 into the branch connector 200 as illustrated in FIG. 5. Additionally, the preferred protective device 100 is configured for removal or release from the sprinkler 20, preferably by hand, preferably after installation of the sprinkler 20 into the branch connector 200, in order to place the sprinkler 20 into service.

With reference to FIGS. 1A-1B, 2A-2B, and 4A-4B in preferred embodiments of the protected fire protection sprinkler assembly and its installation, the sprinkler 20 generally includes a frame 30 with a body 32 and a pair of spaced apart frame arms 34a, 34b extending from and preferably diametrically disposed about the body 32. The frame arms 34a, 34b are preferably aligned with one another in plane P that may bisect the body 32. A fluid deflector 40 is coupled to the frame arms 34a, 34b and axially spaced from the body 32. The fluid deflector 40 and the sprinkler 20 can be configured for installation as a pendent sprinkler, as shown, as an upright sprinkler, and/or as a horizontal sprinkler. The sprinkler body 32 includes an internal passageway 35 extending between a fluid inlet 31 and a fluid outlet 33 along a central sprinkler axis X-X. The sprinkler body 32 is configured for installation in the branch connector 200; and in preferred embodiments of the sprinkler 20, the body 32 includes an external thread 21 formed about the central sprinkler axis X-X for a preferably threaded connection to the branch connector 200.

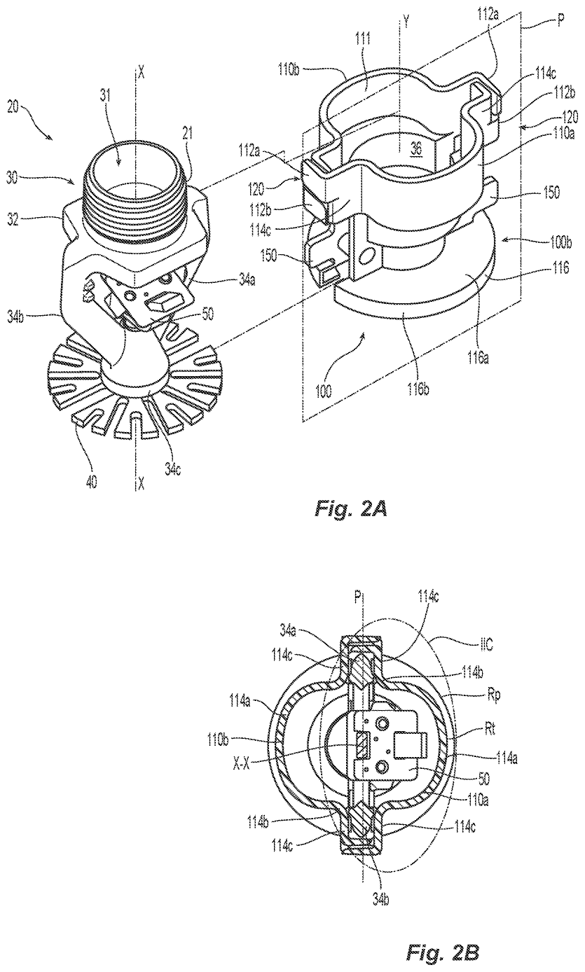

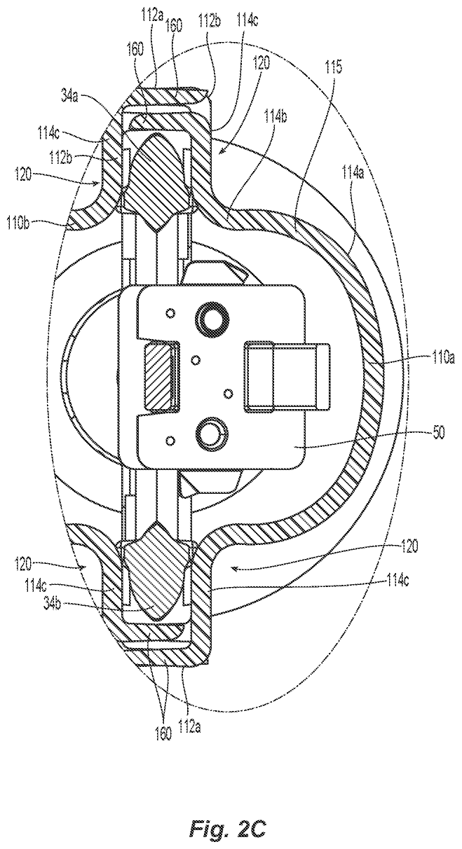

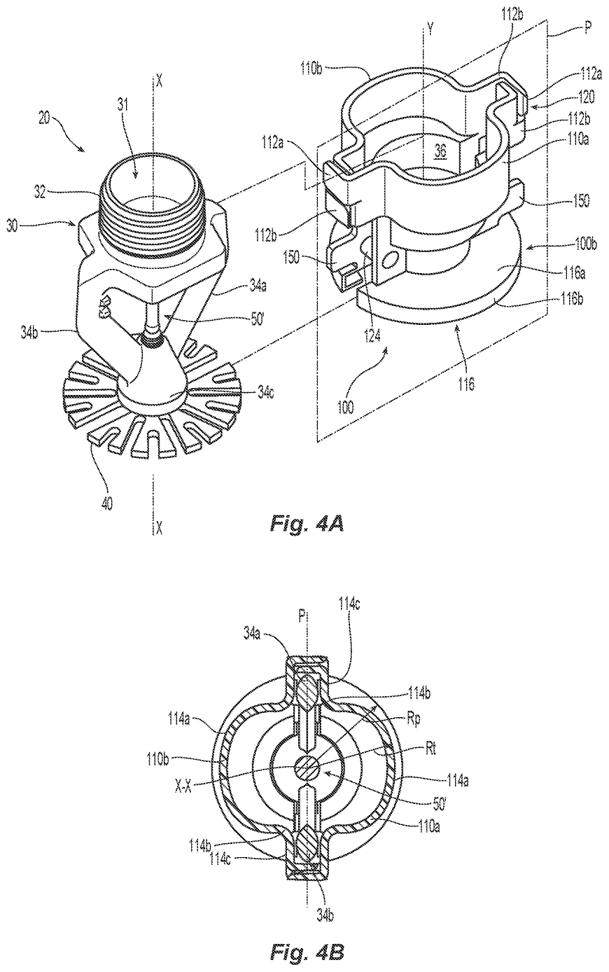

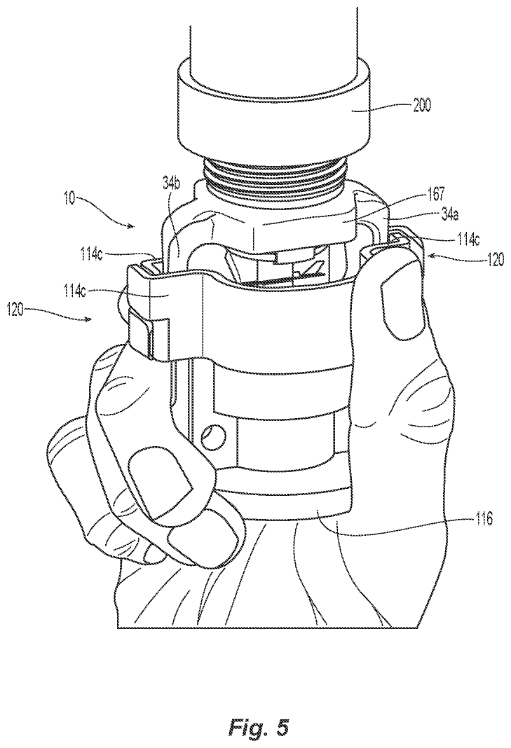

The sprinkler 20 is preferably an automatic sprinkler with a thermally responsive trigger, and, more preferably, a thermally responsive trigger assembly 50 disposed between the body 32 and the fluid deflector 40 (e.g., coaxially between). A preferred embodiment of the trigger assembly 50 can be embodied as a solder link with strut and lever assembly as shown in FIG. 2A-2B. Alternatively, the trigger assembly can be a frangible glass bulb with supporting structure to provide an alternative embodiment of the thermally responsive trigger assembly 50′ as shown in FIGS. 4A-4B. As such, the solder link or the frangible glass bulb provide a thermally responsive trigger for the automatic fire protection sprinkler 20 that operates passively in response to temperature. The automatic fire protection sprinkler includes an internal seal assembly 39 that is supported in place by the thermally responsive trigger assembly 50, 50′ to maintain a fluid tight seal. In preferred embodiments of the sprinkler 20, the fluid deflector 40 is affixed to an apex 34c coaxially aligned the central axis X-X, and preferably, surrounds the apex 34c. Alternatively, or additionally, the trigger assembly 50, 50′ and/or seal assembly 39 can incorporate an actuator for a controlled discharge. For clarity, the disclosure uses an apex as a preferred embodiment of the structure that supports the frame arms and fluid deflector but any suitable structure that the frame arms and/or fluid deflector can affix thereon can be used). In the preferred frame 30, the frame arms 34a, 34b preferably converge to form the preferred apex 34c. The thermally responsive trigger assembly 50, 50′ is preferably axially supported by a threaded load screw or member 60 threaded into the apex 34c. Accordingly, the apex 34c is preferably located between the thermally responsive trigger assembly 50, 50′ and the fluid deflector 40. When the sprinkler 20 is installed and placed in service, the trigger assembly 50, 50′ is configured to thermally actuate in response to a fire or sufficient level of heat. Upon thermal actuation, the seal assembly 39 is released and ejected from the outlet 33 preferably under fluid pressure delivered to the inlet 31 from the header 300 and through the branch connector 200. The firefighting fluid is discharged from the open outlet 33 for distribution by the fluid deflector 40 to address the fire event.

Generally, the preferred protection device 100 is a protection tool configured to install and connect the sprinkler 20 to the branch connector 200. Preferred embodiments of the protective device 100 also include one or more torque assist portions 120 or features thereof that facilitate transfer of a torque, and more preferably a hand torque, to the sprinkler 20 by minimizing or eliminating rotational slip or relative rotation between the sprinkler 20 and the device 100. As described herein, the torque assist portion 120 preferably includes an external surface of the device 100 that can be used by a user to apply a gripping and rotational force to the sprinkler 20. The device 100 can remain in place to protect the installed sprinkler 20 until the sprinkler and the sprinkler system are ready to be placed into service. In order to place the sprinkler 20 into service, the protective device 100 must be removed to expose the operational components of the sprinkler 20. Preferred embodiments of the device 100 include one or more releasing segments 150 to facilitate removing the protective device 100 from the sprinkler 20.

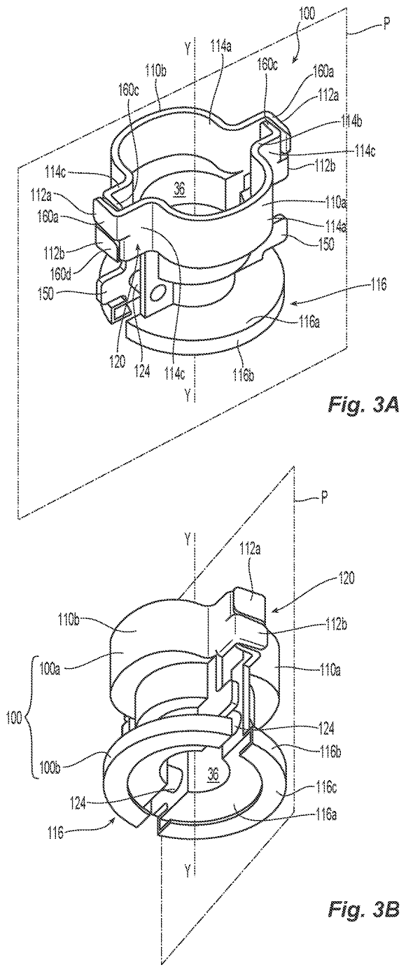

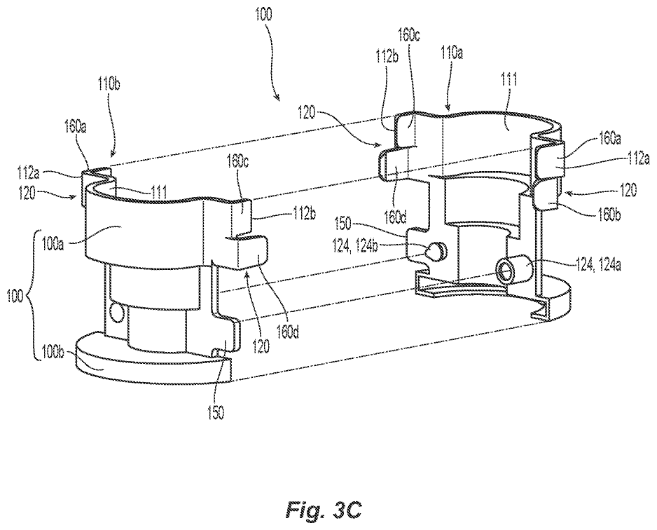

In the preferred sprinkler assembly 10, the protective and installation device 100 is disposed about the fire protection sprinkler frame 30 so as to at least partially circumscribe and protect the thermally responsive trigger assembly 50, 50′ and even more preferably partially circumscribe and protect the fluid deflector 40. As such, the protective device 100 includes a first portion 100a (see FIGS. 3B and 3C) at a first end along the central sprinkler axis X-X that includes the one or more torque assist portions 120 and a second portion 100b at a second end along the central sprinkler axis X-X that includes a deflector protection portion 116. The device 100 is preferably disposed about the sprinkler 20 so as to locate and house operative components of the sprinkler 20 within the internal protective space or void of the device 100. With reference to FIGS. 2A and 4A, the protective device 100 preferably includes a first discrete member 110a and a second discrete member 110b in which they are shown opposed one another about a plane P in a preferred releasable locked arrangement with the pair of frame arms 34a, 34b preferably disposed in the plane P. Each of the preferably opposed members 110a, 110b is a wall structure, and, preferably, a solid wall, and, more preferably, an impervious wall that provides a first shield and an opposed second shield that are releasably locked to one another. As used herein, ‘solid wall’ means a wall structure with an outer perimeter between an interior surface that confronts the sprinkler 20 and an exterior surface exposed for gripping by a user, and the wall structure may have passages, such as, a through-hole, an aperture, and/or an opening so long as such passage does not affect the function of the torque assist portion and the deflector protection portion. In contrast, an “impervious wall” means a wall structure without a passage, such as, a through-hole, an aperture, and/or an opening.

Each of the preferably opposed members 110a, 110b has a first lateral end 112a and a second lateral end 112b disposed laterally about the internal void 36 of the device 100 or the sprinkler 20 housed therein. The opposed members 110a, 110b are preferably coupled to one another about the fire protection sprinkler 20. The members 110a, 110b are preferably identical to one another formed from a polymer or plastic material such as, for example, polyethylene and formed by molding such as, for example, injection molding. Alternatively, or additionally, the protective members 110a, 110b can be formed such that the assembled device 100 is symmetrical or asymmetrical about the plane P. Moreover, the protective members 110a, 110b can be formed so that the assembled device 100 is symmetrical or asymmetrical about another plane that is perpendicular to the plane P and intersecting the central device axis Y-Y as shown in FIGS. 3A-3B.

With reference to FIGS. 3A-3C, for example, to secure the device 100 about the sprinkler 20, the device 100 preferably includes a plurality of releasable lock arrangements 124 to secure the discrete members 110a, 110b of the device 100 about the sprinkler 20. Preferred embodiments of the releasable lock arrangements 124 are independent in that it is the only arrangement or component of the device that can secure the device 100 about the sprinkler 20 given the separate nature of the discrete protective member 110a, 110b. The releasable lock arrangements 124 form a releasable connection between the two discrete protective members 110a, 110b. The interior surface 111 of each protective member 110a, 110b includes one, and preferably more than one, component or element of the releasable lock arrangements 124. Moreover, one or both of the releasable lock arrangements 124 can form the preferred independent releasable lock arrangement as a latched connection. In preferred embodiments of the device 100 and releasable lock arrangements 124, with reference to FIG. 3C and the exploded view of the protective device 100, the first protective member 110a includes one locking element 124a and another locking element 124b and the second protective member 110b, which in a preferred embodiment is identical to the first protective member 110a, also includes locking elements 124a, 124b.

In the preferred embodiment, coupling the identical and opposed first protective member 110a to the second protective member 110b to form the internal void 36 for housing the sprinkler 20 or a portion thereof is achieved by the locking element 124a of the first protective member 110a engaging the locking element 124b of the second protective member 110b and the locking element 124b of the first protective member 110a engaging the locking element 124a of the second protective member 110b. Each locking element 124a preferably includes a boss (such as a cylindrical boss or another suitable shape) extending from the interior surface. Each locking element 124b preferably includes a recess or receptacle (which preferably includes a complementary shape for receiving the locking element 124a, such as a cylindrically shaped opening or another suitable complementary shape). Each locking element 124a on one protective member 110a, 110b engages an opposed locking element 124b on the other protective member 110a, 110b in a preferred frictional or interference fit such as, for example a snap-fit connection, to connect the discrete members 110a, 110b to one another in the preferred latched connection and assembled configuration of the device 100. In the assembly of the device 100, the discrete protective members 110a, 110b are opposed to one another and drawn together, independent of one another, to bring the locking elements 124a, 124b into engagement. In the preferred embodiment, the releasable lock arrangements 124 also function as a pair of spacers disposed laterally about the device axis Y-Y and/or the sprinkler axis X-X; or in the assembly 10, the releasable lock arrangements 124 are radially disposed about each side of the apex 34c between the members 110a, 110b with each protective member 110a, 110b having one locking element 124a (e.g., the boss or insert) and one locking element 124b (e.g., the recess or receptacle). Additionally, one or both of the preferred members 110a, 110b can include other internal formations that extend toward and preferably perpendicular to the plane P to surround and/or contact the thermally responsive trigger assembly 50, 50′. The formations preferably stabilize the protective device 100 about the frame 30 and more preferably center the thermally responsive trigger 50, 50′ within the device 100. The releasable lock arrangements 124 are preferably located radially inward with respect to the lateral ends 112a, 112b and in particular, located radially inward of the preferred releasing segment 150.

In the assembled configuration of the device 100, the releasable lock arrangements 124 extend perpendicularly to the plane P between the members 110a, 110b to space the members 110a, 110b apart from one another. In the preferred protected sprinkler assembly 10, the first and second members 110a, 110b are spaced apart from one another about the plane P. The torque assist portions 120 may include a segment 114c on each of the opposed lateral ends 112a, 112b that confronts one of the frame arms 34a, 34b. The segments 114c on one member 110a are spaced apart about the plane P. More particularly, in the preferred assembly 10, the segments 114c of the first member 110a and the segments 114c of the second member 110b are positioned opposite one another about the plane P, with one frame arm 34a disposed between one pair of opposing segments 114c and the other frame arm 34b disposed between the other pair of opposing segments 114c. In some embodiments, the first member 110a is identical to the second member 110b, such that, advantageously, only one member may be produced and two such members can be joined together to form the device 100.

In preferred embodiments of the protective device 100, the device can be grasped by the hand of a user and the two members 110a, 110b can be drawn toward one another to grip the sprinkler 20. Illustrated in FIG. 5 is the protected sprinkler assembly 10 being installed into the branch connector by hand. The preferred protective device 100 peripherally protects operative components of the sprinkler 20 including the trigger assembly 50, 50′ and the fluid deflector 40. Additionally, the device 100 can protect the hand of the user from the surface edges, and, in particular, an edge of the fluid deflector 40 of the sprinkler 20.

In the discussion below, for clarity, embodiments of the present disclosure are described using fin-shaped projecting elements (“stabilizing fins”). In the preferred embodiment, with reference to FIGS. 1A and 2C (and as shown in other Figures) each of the opposed lateral ends 112a, 112b of each member 110a, 110b is also disposed to extend at least partially around an adjacent frame arm 34a, 34b. More specifically, when the device 100 is secured about the sprinkler 20, the opposed lateral ends 112a, 112b of each member 110a, 110b together surround the radially outermost portions of the frame arms 34a, 34b. In the preferred embodiment, each lateral end 112a, 112b includes one or more (such as two) stabilizing fins 160 extending transversely (e.g., perpendicularly) from the outermost end (relative to the axis Y-Y) of each segment 114c, past the plane P (i.e., toward the other member 110a, 110b). The stabilizing fins 160 of one member 110a, 110b overlap with the stabilizing fins 160 of the other member 110a, 110b to collectively surround the frame 30 (i.e., surrounding the maximum radial extent of the frame arms 34a, 34b from the device axis Y-Y or the central sprinkler axis X-X).

More specifically, each lateral end 112a, 112b includes stabilizing fins 160 that are distributed along the device axis Y-Y, but radially offset from each other relative to the device axis Y-Y, such that one stabilizing fin 160 is more radially inward than the other stabilizing fin 160 on the same lateral end. The radial offsets facilitate enmeshing of the stabilizing fins 160 with each other to collectively surround the frame arms 34a, 34b. In the preferred embodiment, as labeled in FIGS. 3A and 3C, the first lateral end 112a includes a first stabilizing fin 160a and a second stabilizing fin 160b distributed along the device axis Y-Y, but radially offset from each other such that the first stabilizing fin 160a is farther from the device axis Y-Y than is the second stabilizing fins 160b. Also in the preferred embodiment, the second lateral end 112b includes a third stabilizing fin 160c and a fourth stabilizing fin 160d distributed along the device axis Y-Y, but radially offset from each other such that the third stabilizing fin 160c is closer to the device axis Y-Y than is the fourth stabilizing fin 160d. The first stabilizing fin 160a and the third stabilizing fin 160c are disposed at the same position as each other along the device axis Y-Y, but they are not equally spaced from the device axis Y-Y, for example, the third stabilizing fin 160c is radially inward (closer to the device axis Y-Y), and the first stabilizing fin 160a is radially outward (farther from the device axis Y-Y).

This preferred arrangement facilitates the first and third stabilizing fins 160a, 160c overlapping each other when the members 110a, 110b are brought together. The first and third stabilizing fins 160a, 160c together can encircle the frame arms 34a, 34b. In a similar manner, the second stabilizing fin 160b and the fourth stabilizing fin 160d are disposed at the same position as each other along the device axis Y-Y, but they are not equally spaced from the device axis Y-Y. In other words, the first and third stabilizing fins 160b are laterally offset relative to the second and fourth stabilizing fins 160b along the plane P. This preferred arrangement facilitates overlapping the second and fourth stabilizing fins 160b, 160d to encircle the frame arms 34a, 34b when the members 110a, 110b are brought together.

In some embodiments of the protective device 100, depending on the size and or shape of the frame 30 and/or the frame arms 34a, 34b, each of the lateral ends 112a, 112b of the respective first and second members 110a, 110b (specifically, each of the laterally-extending segments 114c) grips the respective frame arm 34a, 34b, and is also contiguous, that is, in contact with at least a portion of the respective frame arm 34a, 34b when the releasable lock arrangements 124 secure the first and second members 110a, 110b about the sprinkler 20. Alternatively, depending on the size and or shape of the frame 30 and/or the frame arms 34a, 34b, one or all of the lateral ends 112a, 112b of the respective first and second members 110a, 110b are spaced from the respective frame arm 34a, 34b when the releasable lock arrangements 124 secure the first and second members 110a, 110b about the sprinkler 20, and may only grip the respective frame arm 34a, 34b to become contiguous with the respective frame arm 34a, 34b when a user grasps, squeezes, and/or rotates (against friction between the external thread 21 and the branch connector 200) the protective device 100, as shown in FIG. 5.

Once installed, the protective device 100 can remain in place to protect the sprinkler until the system is ready to be placed into service. Once the sprinkler 20 and system are ready to be placed into service, the device 100 must be removed to expose the operational components of the sprinkler 20 for providing the desired fire sprinkler protection. To facilitate removal of the device 100 from the sprinkler 20 and in order to place the sprinkler into service, preferred embodiments of the device 100 include the one or more releasing segments 150 to remove the device 100 from about the sprinkler 20. Each releasing segment 150 is preferably configured to separate the protective members 110a, 110b from one another. In preferred embodiments, each releasing segment 150 is integrally formed as a segment of one or both of the discrete protective members 110a, 110b. Each releasing segment 150 can function as a lever with which a force can be applied to separate the protective members 110a, 110b from one another and release the device 100 from its position about the sprinkler 20. The releasing segment 150 is preferably formed as a laterally extending tab that is disposed laterally of the central axes X-X, Y-Y. Each releasing segment 150 is preferably located along the lateral end 112a of one, and preferably both, of the protective members 110a, 110b, or otherwise extending radially outwardly from the device 100. The preferred releasing segment 150 is shown as a tab that is a substantially planar member extending parallel to the plane P which can be grabbed by hand and pulled to release the one or both of the releasable lock arrangements 124 and separate the protective members 110a, 110b from one another. The preferred planar member of the releasing segment 150 has a plurality of linear sides and an inner surface 150a relative to the internal void of the device 100 and an outer surface 150b opposite the inner surface 150a. A releasing segment 150 can be alternatively shaped and/or located along the one or more protective members 110a, 110b provided that the releasing segment can be used to apply a force to disassemble the device 100. For example, the preferably planar tab member of the releasing segment 150 can be angled or skewed with respect to the plane P. Moreover, the tab member of the releasing segment 150 can be alternatively shaped or have surface treatment so as to form a non-planar member, for example, a curved tab member, that can be preferably gripped by hand for releasing the device 100 from about the sprinkler 20.

In the protected assembly 10, the preferred releasing tab provided by the releasing segment 150 is preferably laterally disposed so as to expose each surface 150a, 150b for grabbing, handling, pushing, and/or pulling by a user to apply a separating force. The tab of the releasing segment 150 can be disposed relative to other components of the device 100 to facilitate release of the device 100 from the sprinkler 20. In preferred embodiments of the assembly 10 and device 100, each of the releasable lock arrangements 124 and the releasing segment 150 are disposed laterally about the apex 34c. Moreover, the releasable lock arrangements 124 and releasing segment 150 are preferably aligned with one another in the lateral direction about the apex 34c. In the preferred embodiment shown, the releasable lock arrangements 124 and the releasing segment 150 are axially aligned proximate or closer to the apex 34c than the outlet 33 of the sprinkler. Additionally, the external torque assist portion 120 of the device 100 is located axially between the sprinkler outlet 33 and the apex 34c, preferably axially closer to the outlet 33 than to the apex 34c. Accordingly, the releasing segment 150 and the releasable lock arrangements 124 are axially spaced from the preferred torque assist portion 120. In preferred embodiments, the releasing segment 150 is axially located between the fluid deflector 40 and the torque assist portion 120.

Each of the first and second members 110a, 110b have a geometric profile that facilitates sprinkler protection and handling of the assembly 10. In preferred embodiments described herein, the protective device 100 includes the first portion 100a for protecting the thermally responsive trigger assembly 50, 50′ and preferably the second portion 100b for protecting the fluid deflector 40. In preferred embodiments of the device 100, at least one, and preferably both, of the first and second members 110a, 110b include the torque assist portion, which has a shielding segment and a convex segment, with respect to the internal void of the device, and a transition therebetween. The first and second members 110a, 110b form a space therebetween, including a first space inside the first portion 100a of the device for protecting the thermally responsive trigger assembly 50, 50′. The second portion 100b of the device 100 includes a second space between the members 110a, 110b for protecting the fluid deflector 40. The second space in the second portion 100b can have a width that is greater than a width of the first space in the first portion 100a. At least one, and preferably both, of the protective members 110a, 110b includes a concave segment 114a, and a convex segment 114b, each arranged relative to the central sprinkler axis X-X, to provide the internal void 36 of the protective device 100 for the thermally responsive trigger assembly 50, 50′ to be contained therein to form the shielding segment of the device 100 or a portion thereof. The concave segment 114a is formed to partially circumscribe and shield the thermally responsive trigger assembly 50, 50′. In preferred embodiments, the concave segment 114a includes a variable radius about the central axis X-X.

The shielding portion 100a of the members 110a, 110b can have alternate geometries about the axis X-X provided the geometry can at least partially surround and shield the trigger assembly 50, 50′. In preferred embodiments of the protection members 110a, 110b shown, each of the protective members include a concave segment 114a with two convex segments 114b laterally disposed about the concave segment 114a. Preferably, the central concave segment 114a and lateral convex segments 114b are contiguous with one another to form a preferred inflection transition 115 of the protective member 110a, 110b. For the preferred protective device 100, the transition 115 provides an external surface of the torque assist portion 120 of the device at each lateral end 112a, 112b of the protective members 110a, 110b that can be used for applying a torque to the protected assembly 10 to facilitate installation of the sprinkler 20 into the branch connector 200 or other fitting. The convex segment 114b is a preferred external finger rest or thumb drive against which a hand torque can be applied as illustrated in FIG. 5. Additionally, or alternatively, the external surface of the convex segment 114b can include other surface features to form the preferred finger or thumb rest. In the preferred sprinkler assembly 10, the convex segment 114b is preferably laterally located between the thermally responsive trigger assembly 50, 50′ and one frame arm to form the preferred external torque assist surface. Accordingly, the protective device 100 provides a preferred method for protecting and installing a fire protection assembly 10 that includes shielding the thermally responsive trigger with a concave segment 114a of a protective member 110a, 110b relative to the central sprinkler axis X-X; and torquing the sprinkler assembly 10 into a branch connector 200 with a convex segment 114b and/or the lateral segment 114c extending laterally from the convex segment 114b of the protective member 110a, 110b relative to the central sprinkler axis X-X.

The laterally-extending segment 114c, preferably, extends parallel to the plane P to provide a planar segment of the torque assist portion 120, and, preferably, is configured contiguously with the concave and convex segments 114a, 114b so that the convex segment 114b is located between the concave segment 114a and the segment 114c. Accordingly, the torque assist portion 120 includes one or more of the segment 114c, the convex segment 114b, the concave segment 114a, and the inflection transition 115. With reference to FIGS. 2B and 2C, each preferred segment 114c of the torque assist portion 120 is located to confront, and, in some embodiments, contact a frame arm 34a, 34b. The planar releasing segment 150 extends radially outside the confronted frame arm 34a. In an alternate embodiment in which the planar releasing segment 150 is skewed with respect to the plane P, the releasing segment 150 is skewed with respect to the segment 114c of the torque assist portion 120.

The protective device 100 is located axially to extend from the frame body 32 to the fluid deflector 40. Additionally, the protective device 100 is disposed about the frame 30 to expose the wrench boss 167 of the sprinkler frame for use of the protective device 100 in combination with a wrench to install the sprinkler, if desired. The protective device 100 extends axially to the fluid deflector 40 and more preferably at least peripherally surrounds the fluid deflector 40 and even more preferably house the fluid deflector 40. In preferred embodiments of the device 100, each of the first and second members 110a, 110b includes a first maximum radius of the first protective portion 100a from the central sprinkler axis for protecting the thermally responsive trigger assembly 50, 50′ assembly and a second maximum radius of the second protective portion 100b from the central sprinkler axis for protecting the fluid deflector 40 in which the second maximum radius is preferably greater than the first radius. As seen in FIGS. 3A and 3B, the concave segment 114a includes the preferred first maximum radius and the first protection portion 100a of the device 100 preferably narrows in the axial direction toward the second protection portion 100b. The first portion 100a can narrow uniformly or more preferably narrow in a step-wise fashion as shown. The step-wise fashion can be provided by a plurality of central segments with one or more of the central segments, preferably, having a curved portion disposed along the central sprinkler axis and a planar portion transverse to a central sprinkler axis of the fire protection sprinkler. Preferably, the central portions are surrounded by portions of the wall structure that are, preferably, planar to the plane, and aligned with the laterally extending segment 114c of the torque assist portion 120 and/or with the releasing segment 150. The plurality of central segments that narrow in the axial direction from the first protection portion 100a toward the second protection portion 100b aids in the user's ability to grip the protected fire protection sprinkler assembly 10. Additionally, the central segment proximate the second protection portion 100b allow for the positioning of the releasable lock arrangements 124 to be positioned about the apex 34c.

With reference to FIGS. 2A-2B, 3A-3C, and 4A-4B, the second protection portion 100b of the device that provides the deflector protection portion 116, preferably includes a radially extending shielding surface 116a disposed normal or perpendicular to the central longitudinal sprinkler axis X-X or device axis Y-Y to protect a surface of the fluid deflector 40 opposed to the outlet 33, and the second protection portion 100b includes a peripheral shielding surface 116b that at least partially circumscribes the fluid deflector 40. Where the peripheral shielding surface 116b of the second portion 100b defines a radial distance Rp, and the preferred releasing segment 150 is preferably formed or has a portion thereof located at a radial distance that is preferably greater than the radial distance Rp. Additionally, the radial distance of radially extending shielding surface positions the peripheral shielding surface 116b at a maximum radius of the radial distance Rp greater than a maximum radius of a radial distance Rt of the trigger shielding segment provided by convex segment 114b of the first protective portion 100a from the central sprinkler axis X-X. In the preferred embodiment shown in FIG. 3B, the second protection portion 100b can include a second radially extending shielding surface 116c parallel to the first radially extending surface 116a and normal to the central axis X-X to form a preferred lower surface or lip for shielding the fluid deflector 40 with the peripheral shielding surface 116b extending between the radially extending shielding surfaces 116a, 116c.

Together, the four stabilizing fins 160a, 160b, 160c, 160d at least resist (e.g., prevent) the members 110a, 110b from moving laterally (a) relative to each other and (b) relative to the sprinkler 20 along the plane P, providing a secure attachment of the device 100 to the sprinkler 20 for enhanced protection of the sprinkler 20 and the user. By surrounding the frame 30 (more specifically, the radially outermost portions of the frame arms 34a, 34b), the device 100 resists lateral movement (i.e., along plane P), which reduces risk of the device 100 contacting the trigger assembly 50. For example, prior to a user gripping the device 100, the device 100 forms boxes around the frame arms 34a, 34b and a barrier around the trigger assembly 50 (e.g., via the concave segments 114a). When a user grips the device 100, depending on the stiffness of the material (which is preferably semi-rigid or at least somewhat pliable), the segments 114c may squeeze against the frame arms 34a, 34b, and the stabilizing fins 160a-d may distort, but may maintain the box around the frame arms 34a, 34b. The inner stabilizing fins 160b, 160c may deflect outwardly until they contact their corresponding outer stabilizing fins 160a, 160d, further locking the box shapes around the frame arms 34a, 34b. The outer stabilizing fins 160a, 160d function as stops to prevent the members 110, 110b from sliding relative to each other or relative to the sprinkler 20 to ensure that the concave segments 114a and other adjacent components of the torque assist portions 120 remain spaced apart and out of contact with the trigger assembly 50, thereby protecting the trigger assembly 50 even during installation (i.e., gripping the device 100). In general, squeezing the device 100 further improves grip on the sprinkler 20 and results in less overall deflection of the installation tool/cap than designs that do not surround the frame arms 34a, 34b. The stabilizing fins 160 may or may not have a friction fit between them where they overlap. Preferably, the opposing surfaces of overlapped stabilizing fins 160 are planar surfaces.

Illustrated in FIG. 5 is the protected fire protection sprinkler assembly 10 being installed into the branch connector by hand. The preferred protective device 100 peripherally protects operative components of the sprinkler 20 including the trigger and the fluid deflector. The external surface of the torque assist portion 120 provides a finger rest and more preferably a thumb rest against which the installer can exert a force to torque the sprinkler 20 into the branch connector 200. With a thumb exerted against one device member 110a, the remaining fingers can curl about the other device member 110b. Once installed, the device 100 can be removed or released from the sprinkler 20 by pulling the preferred releasing segment(s) 150 to thereby expose operational components of the sprinkler 20 for service.

Referring again to FIGS. 1A and 1B, preferred embodiments of the protected sprinkler assembly are configured for hand installation into the branch connector 200 in a fluid tight connection. The branch connector 200 shown is generally a tubular member having a first inlet end 212 for connection to the pipe header 300 and a second outlet end 214 for a preferred threaded connection to the fluid distribution device 20. Depending upon the configuration of the fluid deflector 40 of the sprinkler 20, the branch connector 200 can be arranged on the header 300 (e.g., connected via welding, as shown, or glued, or integrally formed, or the connector 200 and header 300 can be a pre-made fitting) for appropriate installation as pendent, an upright or a horizontal sprinkler. The branch connector 200 can be configured as a straight fitting or alternatively can be formed as a different type of fitting, such as for example, an elbow fitting or tee fitting to connect an appropriately configured sprinkler. The branch connector 200 can be preferably configured as shown in U.S. Pat. No. 11,872,425, which is hereby incorporated by reference in its entirety. Preferred embodiments of the branch connector 200 include an internal annular seal member for formation of a fluid tight sealed connection with the protected sprinkler assembly 20. The branch connector 200 includes a preferred internally formed gasket chamber 230 in which an annular seal member 240 is disposed. The annular seal member 240 is preferably configured as the seal shown in U.S. Pat. No. 10,744,527, which is hereby incorporated by reference in its entirety, to provide a preferred leak-proof connection between a fire protection sprinkler or other fire protection device and the branch connector 200. The material employed for seal member 240 is, preferably, an EPDM material having a durometer hardness of from 65 to 80, and preferably 70, to provide the desired sealing function and maintain sprinkler position. Firefighting fluid fed into the inlet end 212 flows through the annular seal member out the outlet end 214 to supply the sprinkler 20 for discharge and distribution in accordance with the performance specification of the sprinkler 20.

The connector 200 includes an internally threaded portion 220 proximate the outlet end 214 for coupling preferred embodiments of the protected fire protection sprinkler assembly 10 and more preferably coupling the protected fire protection sprinkler assembly 10 by hand torque using preferred embodiments of the protective device 100 described herein. The outlet end 214 and internally threaded portion 220 is preferably configured for connection with the fire protection sprinkler 20 of a nominal size. Accordingly, preferred embodiments of the branch connector 200 at the outlet end 214 include a nominal size or diameter ranging from ½ inch to 1½ inch and more particularly any one of: ½ inch, ¾ inch, 1 inch, 1¼ inch or 1½ inch. The outlet end 214 preferably includes a circular planar surface circumscribed and disposed orthogonally with respect to the central longitudinal axis X-X.

Generally, the external thread of the body 32 of fire protection sprinkler 20 of the protected fire protection sprinkler assembly 10 is, preferably, of a tapered form, for example, NPT thread, but can be straight in some embodiments. The internal threaded portion 220 preferably includes internal, preferably, straight threads for receipt of the preferably tapered thread of the fire protection sprinkler 20. The threaded engagement remains fluid tight by compression and proper sealed engagement between the seal member 240, branch connector 200 and the sprinkler 20. The internal diameter ID of the internal preferably straight thread can be defined by any one of the pitch diameter, minor diameter or major diameter of the internal threaded portion 220 provided the preferably straight thread engages the preferably tapered thread of the sprinkler 20. The internal preferably straight thread can be for example, a 1-11.5 NPSH Thread; a ¾-14 NPSH Thread; or a ½-14 NPS Thread for mating with a correspondingly nominal 1 inch, ¾ inch or ½ inch fire protection sprinkler.

Use of the preferred straight internal thread permits preferred embodiments of the protected fire protection sprinkler assembly 10 to be rotatable about the axis X-X within the branch connector 200, preferably by hand, in any desired position while forming a proper fluid tight seal. More preferably, the internal thread portion 220 and the seal member 240 form a proper fluid tight seal engagement with the fire protection sprinkler 20 upon sufficient hand torque using preferred embodiments of the protective device 100. Threaded installation of the sprinkler 20 deforms the annular seal member 240 and provides a leak-proof fluid-tight seal between the sprinkler 20 and the branch connector 200. The connection between the branch connector 200 and the sprinkler 20 is sufficient to provide a fluid tight seal under a fluid pressure of up to 200 psi or more, for example, pressures of up to and including at least 175 psi.

The discharge or flow characteristics of the fire protection sprinkler 20, and, in particular, from the sprinkler body 32, is defined by the internal geometry of the sprinkler including its internal passageway, inlet and outlet (the orifice). Generally, the size of the sprinkler discharge orifice is defined by the nominal K-factor of a sprinkler. For a given sprinkler assembly, typically, the larger the K-factor, the larger the discharge orifice, and the smaller the K-factor, the smaller the discharge orifice. Nominal K-factors for sprinklers listed in the National Fire Protection Association Standard Publication, NFPA 13: Standard for the Installation of Sprinkler Systems, can range from 1 to 30 [GPM/(psi.)^{1/2}] and greater. NFPA 13 identifies the following nominal K-factors of 14 or greater: 14[GPM/(psi.)^{1/2}] (“K14”); 16.8[GPM/(psi.)^{1/2}] (“K16.8”); 19.6[GPM/(psi.)^{1/2}] (“K19.6”); 22.4[GPM/(psi.)^{1/2}] (“K22.4”); 25.2[GPM/(psi.)^{1/2}] (“K25.2”) and 28.0[GPM/(psi.)^{1/2}] (“K28”). Even larger nominal K-factors are also possible. As is known in the art, the K-factor of a sprinkler is defined as K=Q/P^{1/2}, where Q represents the flow rate (in gallons/min GPM) of water from the outlet of the internal passage through the sprinkler body and P represents the pressure (in pounds per square inch (psi.)) of water or firefighting fluid fed into the inlet end of the internal passageway through the sprinkler body. Accordingly, the designed performance of a sprinkler is a function of the supply of a minimum fluid pressure or flow.

The length L of the branch connector 200 is preferably defined between the outlet end 214 and a mid-point of the concave portion of the saddle-shaped inlet end 212. The overall length L of the branch connector between the inlet end 212 and the outlet end 214, preferably, ranges from 1 inch to 1½ inch, in order to ensure the identified discharge or flow characteristics of the fire protection sprinkler, and, in particular, the sprinkler body 32, is achieved when the fire protection sprinkler 20 is installed in the branch connector 200. Moreover, the overall length L of the branch connector 200 preferably corresponds or varies with the outlet nominal diameter size. For example, for a nominal outlet diameter of 1 inch, the length L is preferably 1¼ inch, where the nominal outlet diameter is ¾ inch, the length L is preferably 1⅛ inch and where the nominal outlet diameter is ½ inch, the length L is preferably 1 1/16 inch.

For purposes of the present disclosure, a first element that is positioned “toward” an end of a second element is positioned closer to that end of the second element than to a middle or mid-length location of the second element. Numerical adjectives including “first” and “second,” or the like, as used in the present disclosure, do not convey hierarchy or specific features or functions. Rather, such numerical adjectives are intended to distinguish between elements which may have similar nomenclature, but which may differ in position, orientation, or structure. Accordingly, such numerical adjectives may be used differently in the claims.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A protected fire protection sprinkler assembly comprising:
a fire protection sprinkler including a body having an inlet, an outlet, an internal passageway extending between the inlet and the outlet along a central sprinkler axis, and an external thread formed about the central sprinkler axis, a pair of spaced apart frame arms disposed in a plane and extending axially from the body and converging toward one another to form an apex along the central sprinkler axis and spaced axially from the outlet, a thermally responsive trigger disposed along the central sprinkler axis between the outlet and the apex, and a fluid deflector affixed to the apex, the fluid deflector having an outer perimeter that surrounds the central sprinkler axis; and
a protective torque assist device disposed about the fire protection sprinkler, the protective torque assist device including a first protective member and second protective member opposed from one another about the plane to at least partially surround the thermally responsive trigger,
wherein each of the first protective member and the second protective member comprises an impervious wall having:
a first end located between the outlet and the apex,
a second end that surrounds the outer perimeter of the deflector,
a torque assist portion proximate the first end, wherein the torque assist portion comprises two lateral ends of the impervious wall extending away from the central sprinkler axis, wherein each lateral end includes one or more projecting elements extending toward the plane to at least partially surround one of the frame arms,
a pair of locking elements disposed about the apex, and
a releasing segment proximate the second end and aligned with the pair of locking elements.

2. The assembly of claim 1, wherein, when a torque force is applied on the protective torque assist device, the one or more projecting elements of the first protective member contact the one or more projecting elements of the second protective member to resist lateral movement of the protective torque assist device.

3. The assembly of claim 1, wherein the one or more projecting elements are fin-shaped.

4. The assembly of claim 1, wherein each impervious wall includes an engagement mechanism comprising a friction fit using the one or more projecting elements, the engagement mechanism spaced apart from the pair of locking elements.

5. The assembly of claim 1, wherein, when the first protective member is connected to the second protective member, at least one first projecting element of the one or more projecting elements of the first protective member overlaps with the at least one second projecting element of the one or more projecting elements of the second protective member.

6. The assembly of claim 5, wherein the overlap produces a friction fit between the at least one first projecting element and the at least one second projecting element.

7. The assembly of claim 5, wherein the at least one first projecting element and the at least one second projecting element are spaced apart from each other.

8. The assembly of claim 5, wherein opposing surfaces of the overlapped at least one first projecting element and the at least one second projecting element are planar surfaces.

9. The assembly of claim 1, wherein the first end of the impervious wall comprises a shield segment.

10. The assembly of claim 9, wherein the shield segment comprises a concave segment and two convex segments laterally disposed about the concave segment.

11. The assembly of claim 10, wherein the concave segment is contiguous with the two convex segments.

12. The assembly of claim 11, wherein each torque assist portion comprises a first lateral torque assist portion contiguous with a first of the two convex segments and a second lateral torque assist portion contiguous with a second of the two convex segments.

13. The assembly of claim 12, wherein the first lateral torque assist portion comprises a first planar segment extending parallel to the plane, and the second lateral torque assist portion comprises a second planar segment extending parallel to the plane, wherein the first planar segment carries at least one first projecting element of the one or more projecting elements, and wherein the second planar segment carries at least one second projecting element of the one or more projecting elements.

14. The assembly of claim 13, wherein the at least one first projecting element comprises two first projecting elements, and the at least one second projecting element comprises two second projecting elements.

15. The assembly of claim 14, wherein each of the two first projecting elements are radially offset from each other relative to the central sprinkler axis, and wherein each of the second projecting elements are radially offset from each other relative to the central sprinkler axis.

16. The assembly of claim 15, wherein a first projecting element of the two first projecting elements is positioned at a first distance from the central sprinkler axis, and a first projecting element of the two second projecting elements is positioned at a second distance from the central sprinkler axis that is different from the first distance, wherein when the first protective member is connected to the second protective member, the first projecting element of the two first projecting elements overlaps with the first projecting element of the two second projecting elements.

17. The assembly of claim 1, wherein the second end that surrounds the perimeter of the deflector comprises a first radially extending shielding surface and a peripheral shielding surface that at least partially circumscribes the outer perimeter of the fluid deflector.

18. The assembly of claim 17, further comprising a second radially extending shielding surface, and wherein the peripheral shielding surface extends between the first radially extending shielding surface and the second radially extending shielding surface.

19. The assembly of claim 1, wherein a central section of the impervious wall comprises a central plurality of segments that narrow between the first end and the second end.

20. The assembly of claim 19, wherein each of the plurality of central segments includes a curved portion disposed along the central sprinkler axis and a planar portion transverse to the central sprinkler axis.

21. The assembly of claim 1, wherein the first end of the impervious wall comprises a trigger shield segment for protecting the thermally responsive trigger assembly, the trigger shield segment having a first maximum radius from the central sprinkler axis,
wherein the second end that surrounds the perimeter of the deflector comprises a peripheral shielding surface for protecting the fluid deflector, the peripheral shielding surface having a second maximum radius from the central sprinkler axis, and
wherein the second maximum radius is greater than the first maximum radius.

22. The assembly of claim 1, wherein the pair of locking elements comprises a boss and a receptacle for receiving the boss.

23. The assembly of claim 22, wherein the boss is cylindrical and the receptacle has a cylindrical opening.

24. The assembly of claim 1, wherein the pair of locking elements is disposed on an inner surface of the impervious wall about a central segment that is adjacent the second end.

25. The assembly of claim 24, wherein at least one of the locking elements is disposed laterally between the central segment and the releasing segment.

26. The assembly of claim 1, wherein the first and second protective members are separate and identical.

27. The assembly of claim 1, wherein the releasing segment comprises a planar member extending parallel to the plane from one of a first longitudinal side of the impervious wall or a second longitudinal side of the impervious wall.

28. A protected fire protection sprinkler assembly comprising:
a fire protection sprinkler including a body having an inlet, an outlet, an internal passageway extending between the inlet and the outlet along a central sprinkler axis, and an external thread formed about the central sprinkler axis, a pair of spaced apart frame arms disposed in a plane and extending axially from the body and converging toward one another to attach to a support structure along the central sprinkler axis and spaced axially from the outlet, a thermally responsive trigger disposed along the central sprinkler axis between the outlet and the support structure, and a fluid deflector affixed to the support structure, the fluid deflector having an outer perimeter that surrounds the central sprinkler axis; and
a protective torque assist device disposed about the fire protection sprinkler, the protective torque assist device including:
a first protective member,
a second protective member discrete from, releasably attachable to, the first protective member, wherein the second protective member is disposed opposite from the first protective member about the plane, and wherein the first protective member and the second protective member collectively at least partially surround the thermally responsive trigger and a maximum radial extent of the frame arms,
a deflector protection portion disposed toward a first end in each of the first and second protective members to at least partially surround the fluid deflector, and
a torque assist portion disposed toward a second end in each of the first and second protective members and comprising one or more projecting elements disposed radially outward from the central sprinkler axis and extending transverse to the plane.

29.-57. (canceled)

58. A method of providing a protected fire protection sprinkler assembly, the method comprising:
providing two identical discrete and impervious protective members, each protective member having a torque assist portion and a deflector protection portion; and
securing the protective members to one another with releasable locking elements;
wherein securing the protective members to one another comprises positioning projections of the torque assist portion to overlap with one another, wherein the projections are spaced apart from the releasable locking elements.

59.-81. (canceled)

82. A protected fire protection sprinkler assembly, comprising:
a branch connector comprising,
a body having a first end for coupling to a water supply line and a second end having internal threads for threadably receiving a fire sprinkler head, the body further including an annular sealing surface at the end of the threads;
an annular seal including an annular body having a central opening with an outwardly tapered conical wall, the conical wall terminating in a first annular surface at one end and a second annular surface at an opposite end; and the seal having an outer surface including an inwardly tapered outer conical wall extending to the one end of the seal, wherein the first annular surface is adapted to sealably engage the annular sealing surface of the body and the second annular surface is adapted to be sealably engaged by a sprinkler head,
a fire protection sprinkler including a body having an inlet, an outlet, an internal passageway extending between the inlet and the outlet along a central sprinkler axis, and an external thread formed about the central sprinkler axis, a pair of spaced apart frame arms disposed in a plane and extending axially from the body and converging toward one another to form an apex along the central sprinkler axis and spaced axially from the outlet; and
a protective torque assist device disposed about the fire protection sprinkler, the protective torque assist device including a first protective member and second protective member opposed from one another about the plane,
wherein each of the first protective member and the second protective member comprises a torque assist portion having two lateral ends extending away from the central sprinkler axis, wherein each lateral end includes one or more projecting elements extending toward the plane to at least partially surround one of the frame arms.

83.-89. (canceled)

90. A protected fire protection sprinkler assembly, comprising:
a sprinkler body having opposite first and second ends and a threaded section adjacent the first end;
a thermally responsive element mounted to the sprinkler body;
a branch connector having opposite third and fourth ends and an internal passageway extending therebetween, the third end configured to attach to an access member of a piping system in fluid communication with the passageway, the passageway having a threaded section adjacent said fourth end, and the threaded section including a thread, the passageway includes an annular recess section having an outer wall with an inner diameter that is larger than an inner diameter of the threaded section of the branch connector and a shoulder is disposed at an upstream end of the annular recess section; and
a seal member disposed in the annular recess section against the shoulder of said passageway of the branch connector, wherein the seal member is annular and includes a central opening aligned with the passageway,
wherein the first end of the sprinkler body engages with and compresses the seal member against the shoulder when the threaded section of the sprinkler body is engaged with the threaded section of the passageway and forms a fluid-tight seal between the branch connector and the sprinkler body,
a protective torque assist device disposed about the sprinkler, the protective torque assist device including a first protective member and second protective member opposed to the first protective member,
wherein each of the first protective member and the second protective member comprises a torque assist portion having two lateral ends extending away from a central sprinkler axis, wherein each lateral end includes one or more projecting elements extending toward corresponding projecting elements of an opposing lateral end to at least partially surround a portion of the sprinkler body.

91.-97. (canceled)

98. A protected fire protection sprinkler assembly comprising:
a fire protection sprinkler including a body having an inlet, an outlet, an internal passageway extending between the inlet and the outlet along a central sprinkler axis, and an external thread formed about the central sprinkler axis, a pair of spaced apart frame arms disposed in a plane and extending axially from the body and converging toward one another to attach to a support structure along the central sprinkler axis and spaced axially from the outlet, a thermally responsive trigger disposed along the central sprinkler axis between the outlet and the support structure, and a fluid deflector affixed to the support structure, the fluid deflector having an outer perimeter that surrounds the support structure; and
a protective device disposed about the fire protection sprinkler, the protective device including a first protective member and a second protective member which are identical and opposed from one another about the plane to at least partially surround the thermally responsive trigger, the first protective member and the second protective member defining a torque assist portion, a deflector protection portion, a first releasable lock arrangement through the plane and at a first lateral side of the fire protection sprinkler, second releasable lock arrangement through the plane and at a second lateral side of the fire protection sprinkler, and a releasing segment aligned with the first releasable lock arrangement and second releasable lock arrangement
wherein the torque assist portion of each of the first protective member and the second protective member comprises one or more projecting elements extending toward the plane at the first lateral side and/or the second lateral side to at least partially surround one of the frame arms.

99.-106. (canceled)
